(19) United States
(12) Patent Application Publication
(10) Pub. No.: US 2026/0159933 A1
(43) Pub. Date: Jun. 11, 2026

(54) STRUCTURALLY ENHANCED ROUGHENED FEATURES FOR IMPROVED THERMAL SPRAY DEVICE AND METHOD OF USE FOR PRODUCING UNIFORM COATING PROPERTIES

(71) Applicant: PRAXAIR S.T. TECHNOLOGY, INC., North Haven, CT (US)

(72) Inventor: David A. Somerville, Salisbury, NH (US)

(21) Appl. No.: 18/708,006

(22) PCT Filed: Dec. 17, 2021
(86) PCT No.: PCT/US2021/063971

§ 371 Date: May 7, 2024

(51) Int. Cl. C23C 4/129; C23C 4/134

(52) U.S. Cl. CPC C23C 4/129; C23C 4/134

(57) ABSTRACT

A novel and improved thermal spray component having structurally enhanced roughened features on a wetted surface is provided. The structurally enhanced roughened features on the wetted surface enable a reduction in the accumulation of scale deposits and also improves coating property performance during operation of the thermal spray torch.

### RELATED APPLICATIONS

This application is a 35 U.S.C. § 371 national stage application of International Application No. PCT/US2021/063971, filed on Dec. 17, 2021.

### FIELD OF THE INVENTION

The present invention relates to novel structurally enhanced roughened features on one or more thermal spray components that are incorporated into a thermal spray device. The modified thermal spray components contribute to improved performance of the thermal spray device.

### BACKGROUND OF THE INVENTION

High velocity oxygen fuel (HVOF) is a combustion flame spraying method to create a molten particles that is deposited onto a substate. The thermal spray torch uses a fuel such as propylene or kerosene that is combusted in the presence of oxygen under relatively high pressures in an internal combustion chamber of the thermal spray torch. Combustion gases are produced. In particular, a combustion flame is produced along the inside of the combustion chamber. The temperatures of the combustion flame can reach approximately 2000 deg F. or higher. The combustion gases discharge through a throat portion of the combustion chamber and then flow downstream into an extended barrel, which is an elongated nozzle-like structure. Feedstock in the form of powders or wire of metals or ceramic materials can be fed into the barrel or at an interconnector section located between the combustion chamber and the barrel. When the feedstock is injected, it becomes confined by the combustion gas stream. The feedstock particles exit the barrel in molten form as a high velocity jet stream, which is directed towards a substrate where they deposit to form a coating.

The relatively high temperatures generated from the energy source within the HVOF device can be problematic. The inner surfaces on the barrel and combustion chamber increase in temperature and run the risk of overheating, which can potentially lead to thermal failure. In order to control temperature and mitigate the risks of overheating the inner surfaces of the HVOF torch, cooling water is circulated along various surfaces of thermal spray components of the HVOF torch, including the outer surfaces of the barrel and the combustion chamber to enable extraction of heat from the inside of their respective inner surfaces.

Despite efforts to control the operating temperature of the HVOF torch during its operation, ineffective heat transfer into the cooling water persists. There remains an unmet need for improved thermal spray devices that are capable of operating at elevated power levels without thermal damage.

### SUMMARY OF THE INVENTION

In one aspect, an improved thermal spray apparatus for use in production of a thermal spray coating is provided. The improved thermal spray apparatus comprises: a high velocity oxygen fuel (HVOF) torch for spraying, wherein said torch includes a combustion chamber having an interior volume defined by interior surfaces, said combustion chamber configured to receive oxygen and a fuel and allow combustion reaction products to be produced that generate a heated flow therefrom and which are in contact with said interior surfaces, said combustion chamber comprising a first outer surface in contact with cooling media; a barrel operably connected downstream to said combustion chamber, said barrel having an interior volume defined by interior surfaces configured to be in contact with the heated flow of said combustion reaction products, said barrel comprising a second outer surface in contact with the cooling media; at least one of said first outer surface of said combustion chamber and said second outer surface of said barrel characterized by structurally enhanced roughened features, wherein said structurally enhanced roughened features are configured to reduce an accumulation of scale deposits on said first and/or second outer surface when said first and/or second outer surface is exposed to cooling media during the operation of the HVOF torch.

In a second aspect, an improved thermal spray apparatus for use in a production of a thermal spray coating is provided. The improved thermal spray apparatus spray apparatus comprises: a plasma torch for spraying wherein said torch includes a cathode device, and an anode, said anode having an exterior surface and an interior portion, wherein the interior portion of the anode is operably connected to the cathode device, and further wherein the exterior surface of the anode is in fluid communication with a cooling media; said exterior surface of the anode characterized by structurally enhanced roughened features, wherein said structurally enhanced roughened features are configured to reduce an accumulation of scale deposits on said external surface of the anode when exposed to cooling media during the operation of the plasma torch.

In a third aspect, an improved thermal spray component for use in a thermal spray apparatus to create a thermal spray coating is provided. The improved thermal spray component comprises: a body having a substantially tubular geometry, said substantially tubular geometry having a first end and a second end, wherein a central longitudinal axis traverses the body from the first end to the second end, the body having a first surface that is adapted to be in contact with a plasma arc or combustion reaction products when said thermal spray component is operably connected within the thermal spray apparatus, the body further having a second surface that extends from the first end to the second end, the second surface configured to be in contact with cooling media during operation of the thermal spray apparatus; and a structurally enhanced roughened feature along at least a portion of the second surface, said structurally enhanced roughed feature being oriented substantially parallel to the central longitudinal axis, wherein said structurally enhanced roughened features are configured to reduce an accumulation of scale deposits on said second surface when said second surface is exposed to the cooling media during the operation of the thermal spray apparatus.

In a fourth aspect, an improved thermal spray component for use in a thermal spray apparatus to create a thermal spray coating is provided. The improved thermal spray component comprises: a body having a substantially tubular geometry, said substantially tubular geometry having a first end and a second end, wherein a central longitudinal axis traverses the body from the first end to the second end, the body having a first surface that is adapted to be in contact with a plasma arc or combustion reaction products when said thermal spray component is operably connected within the thermal spray apparatus; the body further having a second wetted surface that extends from the first end to the second end, wherein at least a portion of the second wetted surface comprises a structurally enhanced roughened feature that is configured to be in contact with cooling media during operation of the thermal spray apparatus.

In a fifth aspect, a method of creating consistent coating properties during operation of an improved thermal spray apparatus, comprising the steps of: creating a high temperature energy source with the improved thermal spray apparatus comprising at least one thermal spray component having a wetted surface, said wetted surface having a structurally enhanced roughened feature therealong; introducing powder or wire feedstock into an inlet of the improved thermal spray apparatus; heating the powder or the wire feedstock to produce substantially molten particles; introducing cooling media into the improved thermal spray apparatus so as to contact the wetted surface having the structurally enhanced roughened feature therealong; directing the substantially molten particles onto a substrate to produce a coating, wherein said coating includes at least one coating property that exhibits variation during the operation of the improved thermal spray apparatus that is less than that produced with a thermal spray apparatus that does not contain the at least one thermal spray component, said at least one coating property selected from the group consisting of porosity, deposition thickness, microhardness and residual stress.

### BRIEF DESCRIPTION OF THE DRAWINGS

FIG. 1a is a representative cross-sectional schematic of an improved HVOF device in accordance with the principles of the present invention;

FIG. 1b is an enlarged view of FIG. 1a to show in greater detail a cooling passage through which cooling water flows to cool an outer surface of a barrel having a structurally enhanced roughened feature;

FIG. 1c is an enlarged view of FIG. 1a to show in greater detail a cooling passage through which cooling water flows to cool an outer surface of a combustion chamber having a structurally enhanced roughened feature;

FIG. 2 is a representative schematic of a structurally enhanced roughened feature in accordance with the principles of the present invention;

FIG. 3 shows a photo of a standard manufactured barrel (i.e., smooth barrel) and a standard manufacture combustion tube (i.e., smooth chamber) alongside an inventive structurally enhanced roughened barrel (e.g., ribbed barrel) and an inventive structurally enhanced roughened combustion tube (e.g., ribbed chamber), each of which is in the pre-run condition.

FIG. 4 shows a photo of a new smooth barrel and a new smooth combustion tube after subject to an HVOF baseline test described in Comparative Example 1a;

FIG. 5 shows a photo of a new ribbed barrel in accordance with the principles of the present invention and the smooth chamber employed in Comparative Example 1 after subject to an HVOF test as described in Example 1a;

FIG. 6 shows a photo of a new ribbed chamber and a new smooth barrel in accordance with the principles of the present invention after subject to an HVOF test as described in Example 2a;

FIG. 7 shows a photo of a new ribbed barrel and the ribbed chamber employed in Example 2 in accordance with the principles of the present invention after subject to an HVOF test as described in Example 3a;

FIG. 8 shows a photo of a standard manufactured plasma anode (i.e., smooth anode) after subject to a plasma test as described in Comparative Example 2; and a photo of a new inventive structurally enhanced roughened plasma anode (e.g., ribbed plasma anode) in accordance with the principles of the present invention after subject to a plasma test as described in Example 4;

FIG. 9 shows a photo of a new inventive structurally enhanced roughened barrel (e.g., grit blasted barrel) and a new inventive structurally enhanced roughened combustion tube (e.g., grit blasted chamber) in accordance with the principles of the present invention after subject to a HVOF test as described in Example 5;

FIG. 10 shows a photo of a new smooth chamber and a new ribbed barrel in accordance with the principles of the present invention after subject to an extended HVOF test of 40 hours as described in Example 6; and

FIG. 11 shows a photo of a smooth, as-machined barrel subject to previous testing, and a new inventive structurally enhanced roughened combustion tube (e.g., knurled tube) in accordance with the principles of the present invention after subject to a HVOF test as described in Example 7.

### DETAILED DESCRIPTION OF THE INVENTION

Applicants have surprisingly discovered that modifications to the existing outer surfaces of one or more thermal spray components can result in significant reduction in the accumulation of scaled deposits and furthermore, improve the consistency of coating properties created during operation of the modified thermal spray torch.

“Wetted surface” as used herein and throughout means a surface that is directly or indirectly in contact with a cooling medium.

“Cooling medium” as used herein and throughout means any type of coolant suitable for circulation through a thermal spray device, including, but not limited to water-based coolants (e.g., water).

“Smooth surface” as used herein and throughout means an as-machined component, including, by way of example, a standard, OEM manufactured combustion tube and a standard OEM manufactured barrel, each of which has an outer diameter (OD) with an as-machined surface that is less than an 84 Ra surface finish.

“Ra” is a roughness parameter that means an average surface roughness, and is calculated as the arithmetic average of the absolute values of the profile heights over a mean line or evaluation length, and is indicative of the arithmetic average profile height deviations from the mean line or evaluation length. As used herein and throughout, unless indicated otherwise, the units are expressed in microinches.

“Rz” is a roughness parameter that means an average value of the absolute values of the heights of five highest-profile peaks and the depths of five deepest alleys within a mean line or evaluation length, and typically represents a numerical value that is larger than Ra. As used herein and throughout, unless indicated otherwise, the units are expressed in micrometres.

“Gun” and “torch” have the same meaning as used herein and throughout and may be used interchangeably to mean a thermal spray device, including but not limited to, an HVOF device, a plasma device or a detonation gun (D-gun) device.

The present invention recognizes shortcomings of existing thermal spray devices, such as high velocity oxygen fuel (HVOF) torches and plasma spray arc guns. For example, with regards to HVOF torches, the Applicants have observed that water fouling build-up (i.e., accumulation of scale deposits) onto outer surfaces of the combustion chamber and barrel have a tendency to occur when the outer surfaces are in contact with cooling water during operation of the HVOF torches. In particular, minerals or other contaminants that are inherently present in the cooling water can get extracted from the cooling water and then deposit onto the hot outer surfaces as the cooling water flows directly or indirectly along such surfaces. The accumulation of such scale deposits acts as an insulative layer that can cause increased heat to be generated within the combustion chamber and nozzle during operation of the thermal spray torch. Consequently, the increased heat can no longer be sufficiently dissipated through the combustion chamber and barrel. Eventually, the combustion chamber, barrel and potentially other components of the HVOF torch operate at temperatures that exceed their respective maximum allowable design working temperatures, thereby leading to thermal failure of the torch. An example of a common thermal failure is a melting surface. In the case of a barrel of an HVOF torch, powder particles can become overheated and start to accumulate on the interior surfaces that they contact, which in turn can lead to so-called undesirable “barrel loading.” The thermal failure can be exacerbated and also cause deleterious slag being deposited onto the coating workpiece.

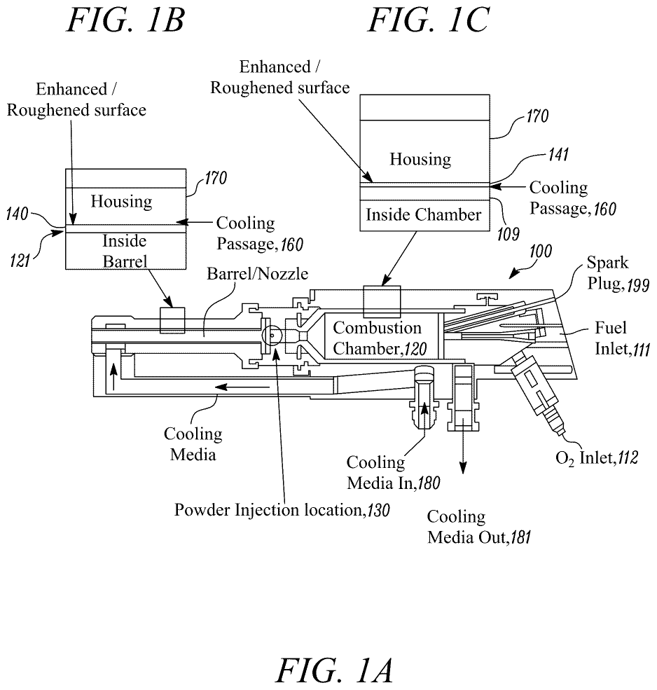

Applicants have recognized the deficiencies of conventional HVOF torches and devised a solution to overcome the same. The present invention has emerged from the shortcomings of conventional HVOF torches. FIGS. 1a, 1b and 1c show an improved HVOF device 100 in accordance with the principles of the present invention. The improved HVOF device 100 includes a combustion chamber 110 and a barrel 120. FIG. 1b shows an enlarged view of the outer surface 121 of barrel 120 with structural enhanced roughened features 140 therealong. FIG. 1c shows an enlarged view of the outer surface 109 of the combustion chamber 110 with structurally enhanced roughened features 141 therealong. The structurally enhanced features 140 and 141 are in direct or indirect contact with cooling passage 160 through which cooling water or other suitable cooling media flows therethrough. Applicants have discovered that the structurally enhanced features 140 and 141 reduce accumulation of water fouling build-up (i.e., scale deposits) along respective barrel outer surfaces 121 and chamber outer surface 109 during operation of the improved HVOF device 100.

Referring to FIG. 1a, in operation, a predetermined flow rate of fuel (e.g., hydrocarbon fuel such as kerosene and the like) is introduced into the fuel inlet 111, and a predetermined amount of oxygen is introduced into the oxygen inlet 112. A current is sent to an electrode of a spark plug 199, thereby causing the fuel to ignite and combust in the presence of the oxygen within the combustion chamber 110. Combustion of the fuel occurs in the combustion chamber 110 to produce combustion reaction products 113 (i.e., flame). The heated flow of combustion reaction products 113 are directed downstream to the barrel 120. A powder is injected at the radial location 130 shown in FIG. 1a. The powder particles come into contact with the combustion reaction products 113 as the combustion reaction products 113 flow from the combustion chamber 110 towards the barrel 120. The molten particles with the combustion reaction products 113 exit the tip of barrel 120. The powder particles became molten as they are directed onto a surface of a substrate.

The large amount of heat generated during the combustion process requires sufficient cooling of the internal components of the HVOF device 100. Applicants have observed that the combustion reaction products 113 can accelerate the rate of scale deposits onto the outer surfaces 121 of barrel and the outer surfaces 109 of combustion chamber 110. Cooling media such as cooling water enters cooling media inlet 180. The cooling water flows through the HVOF device 100 as shown by arrows. The cooling water enters cooling passage 160 as shown in FIG. 1b and FIG. 1c. The cooling passage 160 is located between housing 170 and outer surfaces 121 of barrel 120 and between housing 170 and outer surfaces 109 of combustion chamber 110. As the cooling water flows through cooling passage 160, the cooling water extracts heat from the outer surface 121 of the barrel 120 and the outer surface 109 of combustion chamber 110. At least a portion of the outer surfaces 121 of barrel 120 have structurally enhanced roughened surfaces 140 and at least a portion of the outer surfaces 109 of combustion chamber 110 have structurally enhanced roughened surfaces 141. The structurally enhanced roughened surfaces 140 and 141 are configured to reduce, eliminate and/or suppress the formation of fouling associated with mineral deposits of the cooling water that tend to deposit on corresponding outer surfaces 121 and 109. The cooling water continues to flow through the HVOF device 100, and eventually exits out of HVOF device 100 through cooling media outlet 181. Additional cooling water is re-introduced to continue the cooling. The continuous flow of cooling water over structurally enhanced roughened surfaces 140 and 141 enables effective transfer of heat from the barrel 120 and combustion chamber 110, thereby preventing internal failure such as a melting surface or, barrel loading to occur.

Although both outer surfaces 121 and 109 are shown to have structurally enhanced roughened features 140 and 141, it should be understood that the present invention also contemplates that only one of the outer surfaces 121 or 109 have the imparted structurally enhanced roughened features 140 or 141 along the outer surface 121 or 109.

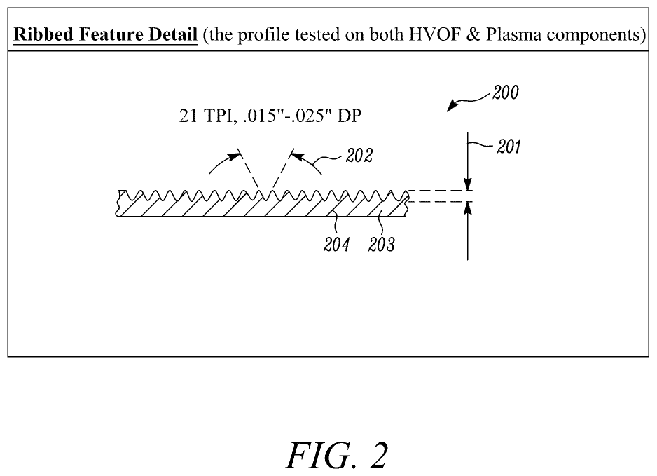

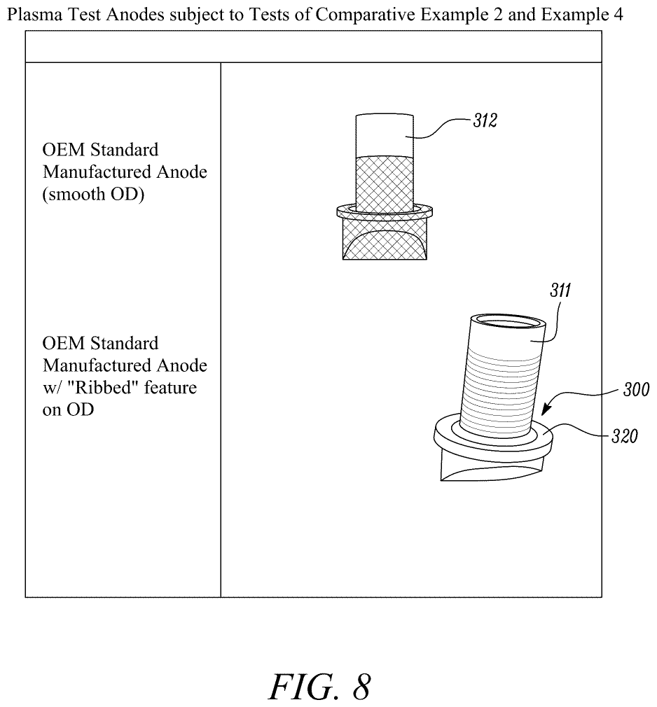

The inventive design can be applicable to any thermal spray component that requires adequate cooling during operation of a thermal spray device. Hence, although FIGS. 1a, 1b and 1c show a HVOF device 100, it should be understood that other thermal spray devices can contain one or more thermal spray components that have structurally enhanced roughened features. By way of example, FIG. 8 shows a photo of a plasma torch 300 having an anode 310 with an outer surface 311 that contains a ribbed feature 320 having structural features that are similar to that shown in FIG. 2. As will be discussed below in conjunction with FIG. 2, the ribbed feature 320 prevents scale build up from minerals of the cooling water on the outer surface 311 during operation of the plasma torch, whereas the as-machined surface of plasma anode 312 is a relatively smoother, non-textured surface that is susceptible to scale buildup as evident by the black scale in the photo of FIG. 8.

An exemplary structurally enhanced roughened surface is shown in FIG. 2. FIG. 2 shows an enlarged view of an outer surface 203 of a thermal spray component with structurally enhanced roughed surfaces characterized as having a ribbed feature 200. The ribbed feature 200 can extend along a portion or the entirety of the outer surface 203. The ribbed feature 200 is characterized by a predetermined depth 201; predetermined helical threads 203 per inch; and groove angle 202. Predetermined depth 201 can be any suitable value as required for the particular thermal spray application. By way of example, and not intending to be limiting, the depth 201 as shown in FIG. 2 ranges from about 0.015 inches to about 0.025 inches. Helical threads 203 define the ribbed feature 200. In the example of FIG. 2, a total of 21 helical threads per inch define the pitch. Other threads per inch are contemplated to produce the requisite Ra and Rz values in accordance with the present invention. The ribbed feature 200 further includes a groove angle 202, which is the angle that is measured between adjacent helical threads 203. The groove angle 202 of FIG. 2 is 55 degrees. Other suitable groove angles can be employed to create the requisite surface texture profile. The ribbed feature 200 as illustrated in FIG. 2 is the design that was used by Applicants in the Examples for both HVOF and plasma devices, which will be described hereinbelow. The ribbed feature 200 successfully prevents scale buildup during operation of the HVOF device and plasma device. The ribbed feature can have an Ra value ranging from greater than 84 up to 1000 or higher as measured by a commercially available surface profilometer.

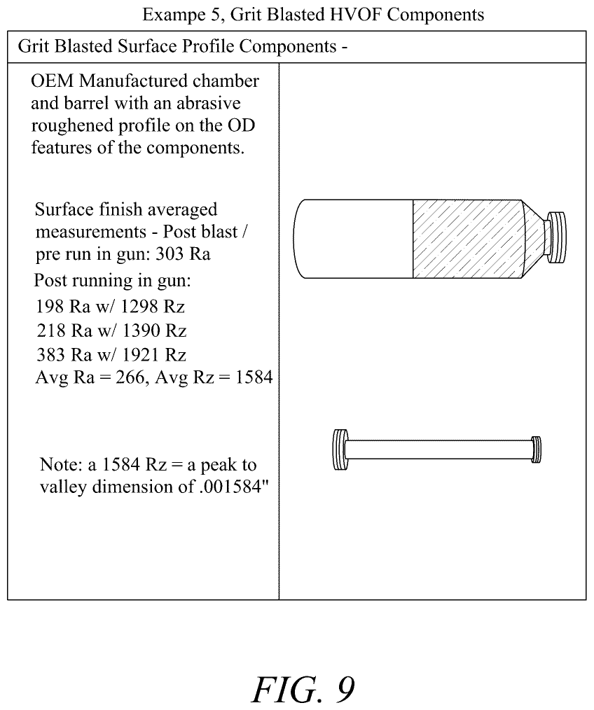

Other types of structurally enhanced roughed features 200 besides the ribbed feature 200 are contemplated by the present invention. In one example, the outer surface 121 of the barrel 120 and/or the outer surface 109 of the combustion chamber 110 is a grit blasted textured profile created with a suitable commercially available abrasive. The grit blasted surface profiles can have a predetermined roughness that is greater than that created by as-machined surfaces, which are generally smoother and characterized by an absence of a textured profile. The grit blasted profiles can have an Ra value ranging from 100 to 500 or higher as measured by a commercially available surface profilometer. FIG. 9 shows an example of an outer surface of a chamber and an outer surface of a barrel both of which have grit blasted roughened surfaces. The chamber has a portion of its outer surface grit blasted, while the barrel has substantially the entirety of its outer surface grit blasted. The outer diameter surface of the barrel was grit blasted and measured to have an Ra of 303 microinches (0.0003 inches) and an Rz of 1804 micrometres (0.0018 inches). Other Ra and Rz values for the grit blasted profile can be utilized. Applicants successfully demonstrated that a HVOF device with the chamber and the barrel having a grit blasted surface texture are able to withstand scale build up. The grit blasted design can comprise any type of outer surface that is adequately surface roughened to impart structurally enhanced roughened features that can withstand scale build up during operation of the HVOF device.

The outer surfaces of the combustion chamber and the barrel of conventional HVOF torches are “as-machined” components that are characterized by an absence of the necessary surface texture profile needed in accordance with the principles of the present invention. Such finishes can be characterized as having an Ra of about 60 microinches or less.

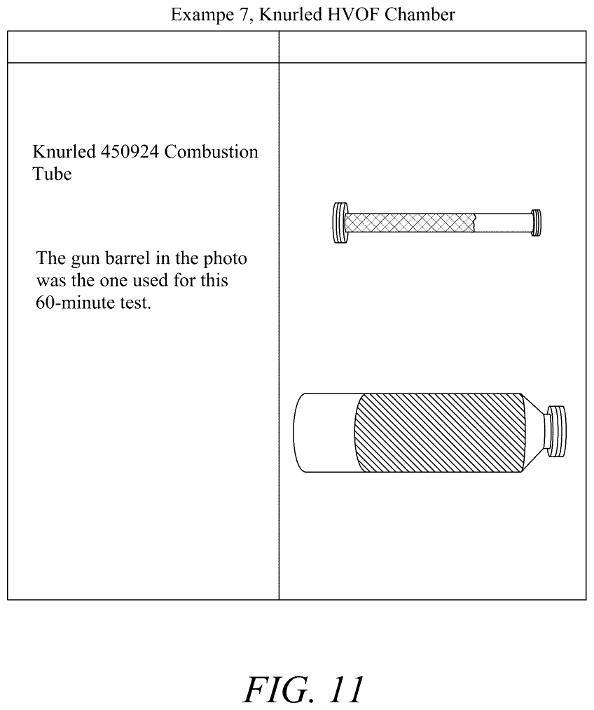

In another example, the outer surface 121 of the barrel 120 and/or the outer surface 109 of the combustion chamber 110 is a knurled roughened surface. FIG. 11 shows one example of a photo of a chamber with a portion of its outer surface created with a knurled roughened surface texture having a raised profile. The knurled raised profile of FIG. 11 has a cut depth that ranges from approximately 0.012″-0.015″ along the outer surface thereof. As will be discussed below, Applicants successfully demonstrated that a HVOF device with the chamber having a knurled surface texture is able to withstand scale build up. Other knurled raised profiles can be utilized by the present invention. The knurling design can comprise any type of protuberance extending from the outer surface so as to create a structurally enhanced roughened texture that can withstand scale build up during operation of the HVOF device.

The above mentioned Figures demonstrate that the present invention contemplates a variety of structurally enhanced roughened features on outer surfaces of thermal spray components that are in contact directly or indirectly with a cooling media during operation of a thermal spray torch. The structurally enhanced roughened features of the present invention have an average surface roughness, designated as Ra, that is greater than 84 or higher, preferably 150 or higher, and most preferably 250 or higher.

Unexpected benefits of the present invention include the ability to create coatings with more consistent properties in comparison to those produced when using conventional thermal spray torches. The Examples below demonstrate that certain coating properties such as % porosity, deposition thickness, microhardness and residual stress can be maintained relatively constant during a thermal spray operation that uses the improved and modified thermal spray apparatus of the present invention. In one embodiment, a method of creating consistent coating properties during operation of an improved thermal spray apparatus is provided. A high temperature energy source or plume is created with the improved thermal spray apparatus comprising at least one thermal spray component having a wetted surface. The wetted surface has a structurally enhanced roughened feature therealong that is in direct or indirect contact with cooling media during operation of the improved thermal spray apparatus. Powder or wire feedstock is introduced into an inlet of the improved thermal spray apparatus. The powder or wire feedstock enters the thermal spray apparatus where it comes into contact with a plume, thereby causing the powder feedstock to become at least substantially molten. Cooling media is introduced into the improved thermal spray apparatus so as to contact the wetted surface having the structurally enhanced roughened feature therealong. In a preferred embodiment, the cooling media is water. The water-cooling circuit can be sourced from the plant closed loop chilled water system. The substantially molten particles are directed onto a substrate to produce a coating. The coating includes at least one coating property that exhibits variation during the operation of the improved thermal spray apparatus that is less than that produced with a thermal spray apparatus that does not contain the at least one thermal spray component with the structurally enhanced roughened feature. The at least one coating property can include porosity, deposition thickness, microhardness and residual stress.

Without being bound by any theory, Applicants have determined that the structurally roughened enhanced features along an outer wetted surface prevents or substantially suppresses or reduces the formation of scaled deposits thereon. In the absence of fouling, the coating properties do not decay, but instead remain relatively constant during the coating process. Additionally, the structurally enhanced features can maintain the same amount of heat within the powder particles which in turn means the amount of heat transfer across the outer wetted surface is relatively constant. On the contrary, and without being bound by any theory, when fouling occurs along the outer wetted surface that is as-machined and does not have a textured profile, there is a decay in the same coating properties as a result of accumulation of scale and minerals that are extracted from the cooling media. These observations are validated by Applicants in the Examples provided hereinbelow.

Additional unexpected benefits of the present invention include extended source life of the thermal spray components with the structurally enhanced roughened features. In this regard, one of the Examples discussed hereinbelow demonstrates the ability for the structurally enhanced roughened feature part to endure a total flame-on time of 40 hours without fouling along the outer wetted surface having the structurally enhanced roughened features, and without hot gas erosion on the inside of the component.

Still further, Applicants have discovered that the benefits of the present invention require a single thermal spray component to be imparted with the structurally enhanced roughened features. For example, an HVOF device in which only one of the combustion chamber and barrel has the outer surface imparted with the structurally enhanced roughened feature can realize the benefits of extended source life and uniform coating properties.

While preferred embodiments of the present invention have been set forth above, the following tests are intended to provide a basis for comparison of the present invention with conventional designs having as-machined smooth surfaces for a barrel and combustion tube. The tests should not be construed as limiting the invention.

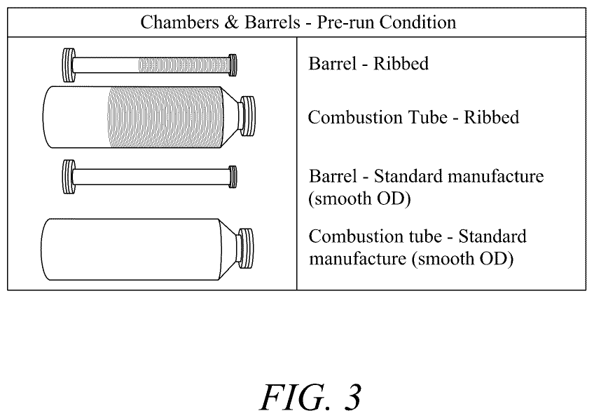

HVOF testing was performed at the PST TAFA Division site, utilizing the JP-8000 thermal spay system with a Model 5220 HVOF thermal spray torch. FIG. 3 shows photos of the smooth barrel and smooth tube (conventional design) and the ribbed barrel and ribbed chamber (present invention) in the pre-test condition. The water-cooling circuit for the torch cooling water was the plant closed loop chilled water system. The parameters used for all the tests were as follows:

### Control Console Flows:

Oxygen—2000 scfh,
Fuel—6.5 gph,
Carrier—26 scfh,
Water—˜10.9 gpm

### Gun Manipulation

Traverse Speed—609 mm/sec
Incremental Step—4 mm
Spray Distance—14.5″

### Coating Material:

Powder Type—88 wt % WC/12 wt % Co
Powder Feed Rate—75 grams/min using a feed wheel rotation speed of 6.3 rpm

By maintaining constant parameters for all tests, a proper comparison of the invention with the conventional gun could be effectively carried out. The gun (i.e., HVOF torch) illustrated in FIG. 1a is representative of the gun that was utilized for all of the tests described hereinbelow. Oxygen was directed at 2000 scfh into an oxygen inlet. Fuel was directed at 6.5 gph into a fuel inlet. A current was sent to an electrode of a spark plug, thereby causing the fuel to ignite and combust in the presence of the oxygen within the combustion chamber and produce combustion gases. A resultant flame was generated. A tungsten carbide cobalt powder with the composition noted hereinabove was radially injected through a powder feeder at a rotational speed of 6.3 rpm to produce 75 grams/min of the powder. A carrier gas at a flow rate of 26 scfh transported the powder from the powder feeder into the body of the gun. The powder particles were directed into contact with the combustion gases as the combustion gases travelled from the combustion chamber towards the barrel. The molten particles with the combustion gases flowed downstream from the combustion chamber into the barrel and thereafter exited the tip of barrel with a HVOF plume. The powder particles became molten as they were directed onto a surface of a substrate. Certain coating properties were measured at the start of the test and at the end of the test to evaluate variation in certain coating properties.

The gun manipulation to apply the coating onto the test sample was accomplished with a robotic system. The robotic system was programmed to operate in accordance with the parameters listed hereinabove, thereby enabling the gun to be maintained at a standoff distance of 14.5″ away from the substrate; and traversed therealong at a rate of 609 mm/sec for a coating pass. Upon completion of the coating pass, the robotic system incrementally moved the gun in an upward or downward direction of 4 mm to allow the next coating pass on the substrate to occur.

Temperature control of the HVOF gun was accomplished with controlled circulation of cooling water through the torch at a flow rate of approximately 10.9 gpm. Cooling water from the TAFA plant was introduced into cooling water inlet and flowed through the torch in the manner indicated in FIG. 1a by the flow arrows. Heat from the combustion products inside of barrel and inside of combustion chamber was transferred into the cooling water. As the cooling water continued to flow within cooling passage in the direction shown by the arrows, additional heat from the inside of combustion chamber was extracted by the cooling water.

A visual inspection of the barrel and chamber after each test run was performed to determine the degree of scale build-up along their respective outer diameters that may have occurred during the test run.

### Comparative Example 1a (Baseline Condition: HVOF Torch with Smooth Combustion Chamber and Smooth Barrel)

The baseline test condition comprised of a Model 5220 gun build with a standard OEM manufactured combustion tube and a standard manufactured gun barrel. The standard OEM manufactured components had a typical “smooth” as-machined finish (i.e., less than 84 Ra finish) along the outer diameter (OD) surfaces. Such smooth features of the outer diameter surfaces were in contact with the cooling water of the gun during operation.

The gun was operated for a test period of slightly over 30 minutes utilizing the procedure and the parameters listed hereinabove to create a thermal spray coating. Thermal spray coatings of the 88WC/12Co powder were produced at the start of the run (i.e., approximately 2 minutes into the run) and at the end of the 30 minute “flame on” cycle.

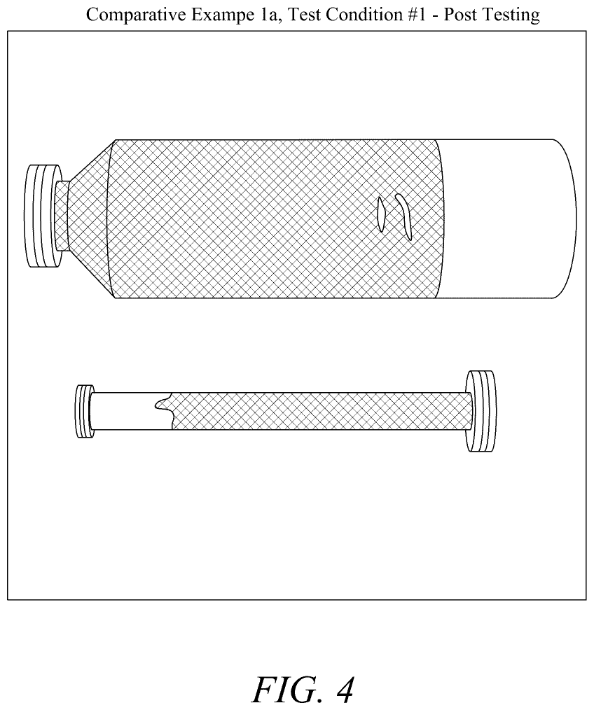

The barrel and chamber were removed from the gun for examination, as shown in FIG. 4. The smooth barrel and smooth chamber both exhibited scale accumulation on their respective OD surfaces. More than half of the surfaces of the smooth barrel and the smooth chamber were covered with scale deposits. The significant accumulation of scale hindered the ability of the cooling water to extract internal heat. This was considered a non-desirable condition. Given the substantial amount of scale buildup during a relatively short test duration, the Applicants expected that internal surfaces of the gun were hotter, and at some point, would be prone to damage, in the form of surface melting and/or hot gas erosion.

### Comparative Example 1b (Coating Property Variation from HVOF Torch)

The thermal spray coating produced in Comparative Example 1a was prepared for evaluation. All of the coating test samples were mounted in an epoxy castable mount, and polished utilizing a semi-automatic polisher. All samples were polished in the same set up.

The coating properties results indicated that after the 30-minute test cycle, there was more than likely a heat increase that was imparted to the powder particles within the spray plume. Table 1 hereinbelow summarizes the variation in the measured coating properties. The decrease in observed porosity, hardness and residual stress are indicators of more heat retained within the flame because of the reduced heat transfer into the cooling water. A decrease in deposition thickness was also noted from the start of the run to the end of the run. The observed cause of this likely heat increase was believed to be the scaling contaminate buildup (fouling) on the water jacket side of the outer surfaces of the combustion chamber and barrel. This was considered a non-desirable condition.

TABLE 1
Test Condition 1 Coating Samples (Baseline Condition)

| | Porosity | Deposition | Microhardness | Residual Stress |
|---|---|---|---|---|
| Sample Set | (%) | (mils) | (dph) | (mils) |
| Beginning | .96 | 11.9 | 1277 | 3.7 |
| End | .40 | 11.4 | 1223 | 3.5 |
| Numerical | .56 | 0.50 | 54 | 0.2 |
| Difference | | | | |
| % Difference | 58% | 4.2% | 4.2% | 5.4% |

### Example 1a (Inventive HVOF Torch with Smooth Combustion Chamber and Ribbed Barrel)

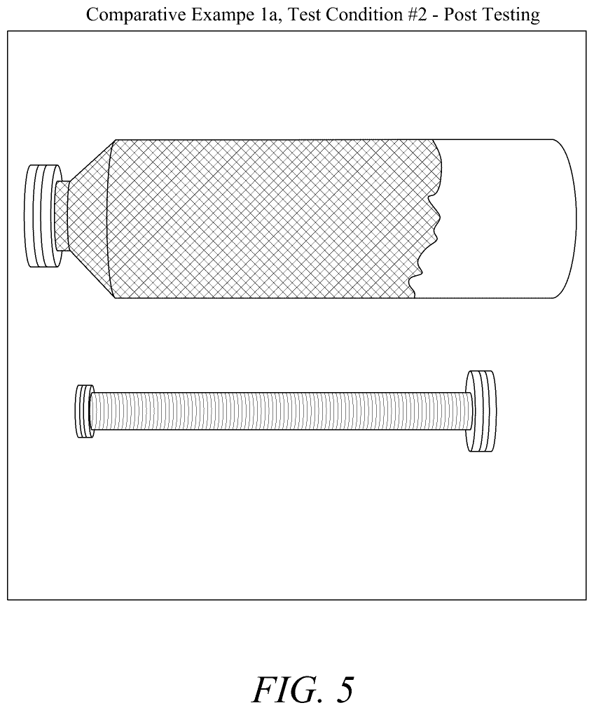

For this test condition, a barrel with a “ribbed” feature on the OD surface that was in contact with the cooling water was installed into the gun. The smooth chamber utilized for this test was the same smooth surface chamber previously used for Comparative Example 1a. The gun was run for a period of 30 minutes, and metallurgical test samples were coated as described in Comparative Example 1a. After the 30 minute test, the ribbed barrel and the smooth chamber were removed from the gun for examination, as shown in FIG. 5. The ribbed barrel did not exhibit any scale build up. The ribbed finished barrel was found to be absent of any scale build up, which was a desirable condition.

### Example 1b (Coating Property Variation from Inventive HVOF Torch)

The thermal spray coatings produced in Example 1a were prepared for evaluation. All of the coating test samples were mounted in an epoxy castable mount, and polished utilizing a semi-automatic polisher. All samples were polished in the same set up.

The test result values for Example 1b samples were substantially the same throughout the duration of test, as shown in Table 2. The coating properties results for this test condition exhibited much less deviation between the beginning and end of the 30-minute cycle coated test samples than observed with Comparative Example 1b. In particular, porosity variation from start to end of the test decreased by only 11%, whereas the porosity variation from start to end in Comparative Example 1b decreased by 58%. Deposition variation from start to end of the test decreased by only 0.7%, whereas the deposition variation from start to end of the test in Comparative Example 1b decreased by 4.2%. Microhardness variation from start to end of the test decreased by 2.5%, whereas microhardness variation from start to end of the test in Comparative Example 1b decreased by 4.2%. Residual stress variation from start to end of the test decreased by 0%, whereas residual stress variation from start to end of the test in Comparative Example 1b decreased by 5.4%. The performance results were a significant improvement over the coatings produced by conventional HVOF torch designs.

In addition to a decrease in scale build up as shown in FIG. 5, Table 2 further validates that during the 30 minute duration, the heat transfer into the powder and spray plume was relatively consistent and unaffected with the use of the ribbed barrel. The tests further demonstrate that having only a single thermal spray component with a surface roughened enhanced feature (e.g., ribbed feature along OD surface) is capable of producing superior improvement with regards to reduction or elimination of scale buildup and creation of uniform coating properties.

TABLE 2
Test Condition 2 Coating Samples

| | Porosity | Deposition | Microhardness | Residual Stress |
|---|---|---|---|---|
| Time | (%) | (mils) | (dph) | (mils) |
| Beginning | 1.33 | 12.6 | 1204 | 2.1 |
| End | 1.19 | 12.5 | 1174 | 2.1 |
| Numerical | 0.14 | 0.1 | 30 | 0.0 |
| Difference | | | | |
| % Difference | 11% | 0.7% | 2.5% | 0% |

### Example 2a (Inventive HVOF Torch with Ribbed Combustion Chamber and Smooth Barrel)

For this test condition, a combustion chamber with a ribbed feature on the OD surface in contact with the cooling water was installed into the gun. The barrel used for this test condition was a standard manufactured barrel with a smooth surface on the OD that was in contact with the cooling water.

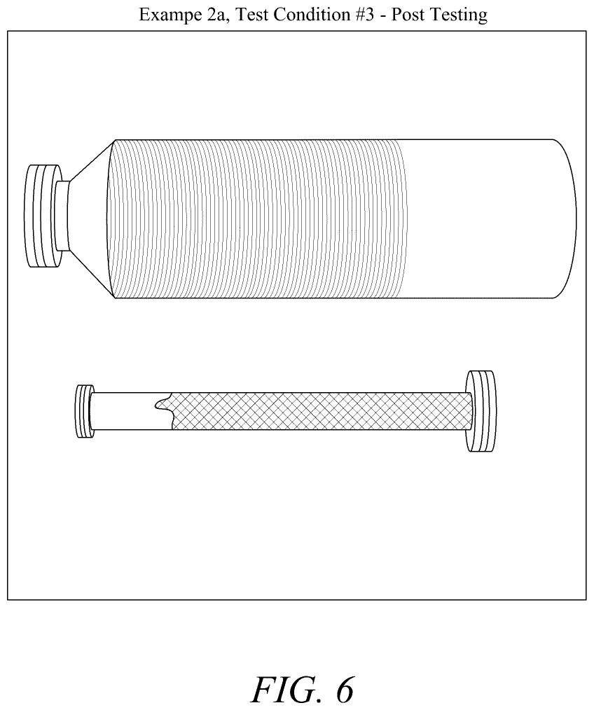

The gun was run for a period of 30 minutes, and metallurgical test samples were coated as described hereinbelow in Example 2b. After the 30 minute test, the smooth barrel and the ribbed chamber were removed from the gun for examination, as shown in FIG. 6.

The ribbed chamber did not exhibit any scale build up, which was a favorable condition. The smooth surface finished barrel did exhibit appreciable scale accumulation on the OD surface, which was an unfavorable result.

### Example 2b (Coating Property Variation from Inventive HVOF Torch)

The thermal spray coatings produced in Example 2a were prepared for evaluation. All of the coating test samples were mounted in an epoxy castable mount, and polished utilizing a semi-automatic polisher. All samples were polished in the same set up.

The test result values for Example 2b samples were substantially the same throughout the duration of test, as shown hereinbelow in Table 3. The coating properties results for this test condition exhibited much less deviation between the beginning and end of the 30-minute cycle coated test samples than observed with Comparative Example 1b. In particular, porosity variation from start to end of the test decreased by only 8.8%, whereas the porosity variation from start to end in Comparative Example 1b decreased by 58%. Deposition variation from start to end of the test decreased by only 1.7%, whereas the deposition variation from start to end of the test in Comparative Example 1b decreased by 4.2%. Microhardness variation from start to end of the test decreased by 1.1%, whereas microhardness variation from start to end of the test in Comparative Example 1b decreased by 4.2%. Residual stress variation from start to end of the test decreased by 4.7%, whereas residual stress variation from start to end of the test in Comparative Example 1b decreased by 5.4%. The performance results were a significant improvement over the coatings produced by conventional HVOF torch designs.

In addition to a decrease in scale build up on the chamber as shown in FIG. 6, Table 3 further validates that over the 30 minute duration, the heat transfer into the powder and spray plume was relatively consistent and unaffected with the use of the ribbed chamber. The tests further demonstrate that having only a single thermal spray component with a surface roughened enhanced feature (e.g., ribbed feature along OD surface) is capable of producing superior improvement with regards to reduction or elimination of scale buildup and creation of uniform coating properties.

TABLE 3
Test Condition 3 Samples

| | Porosity | Deposition | Microhardness | Residual Stress |
|---|---|---|---|---|
| Time | (%) | (mils) | (dph) | (mils) |
| Beginning | .80 | 11.7 | 1161 | 4.2 |
| End | .73 | 11.5 | 1174 | 4.4 |
| Numerical | 0.07 | 0.2 | 13 | 0. |
| Difference | | | | |
| % Difference | 8.8% | 1.7% | 1.1% | 4.7% |

### Example 3a (Inventive HVOF Torch with Ribbed Combustion Chamber and Ribbed Barrel)

For this test condition, a chamber with a ribbed feature on the OD surface in contact with the cooling water was installed into the gun. The ribbed chamber for this test was the same as used in Example 2a. The barrel used for this test condition was a ribbed barrel with a smooth surface on the OD that was in contact with the cooling water.

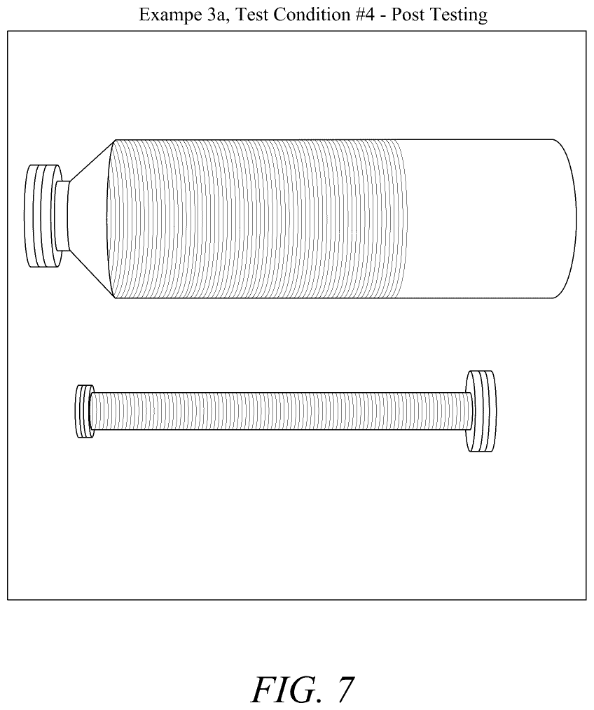

The gun was run for a period of 30 minutes, and metallurgical test samples were coated as described hereinbelow in Example 3b. After the 30 minute test, the ribbed barrel and the ribbed chamber were removed from the gun for examination, as shown in FIG. 7. The ribbed chamber and the ribbed barrel did not exhibit any scale build up, which was a favorable condition.

### Example 3b (Coating Property Variation from Inventive HVOF Torch)

The thermal spray coatings produced in Example 3a were prepared for evaluation. All of the coating test samples were mounted in an epoxy castable mount, and polished utilizing a semi-automatic polisher. All samples were polished in the same set up.

The test result values for Example 3b samples were substantially the same throughout the duration of test, as shown hereinbelow in Table 4. The coating properties results for this test condition exhibited much less deviation between the beginning and end of the 30-minute cycle coated test samples than observed with Comparative Example 1b. In particular, porosity variation from start to end of the test increased by 34%, whereas the porosity variation from start to end in Comparative Example 1b decreased by 58%. Deposition variation from start to end of the test decreased by only 0.8%, whereas the deposition variation from start to end of the test in Comparative Example 1b decreased by 4.2%. Microhardness variation from start to end of the test decreased by 1.4%, whereas microhardness variation from start to end of the test in Comparative Example 1b decreased by 4.2%. It was noted that residual stress variation from start to end of the test increased by 8.6%, whereas residual stress variation from start to end of the test in Comparative Example 1b decreased by 5.4%. With the exception of higher residual stress variation, the performance results were a significant improvement over the coatings produced by conventional HVOF torch designs.

TABLE 4
Test Condition 4 Samples

| | Porosity | Deposition | Microhardness | Residual Stress |
|---|---|---|---|---|
| Time | (%) | (mils) | (dph) | (mils) |
| Beginning | .71 | 12.6 | 1257 | 3.5 |
| End | .95 | 12.5 | 1239 | 3.8 |
| Numerical | 0.24 | 0.1 | 18 | 0.3 |
| Difference | | | | |
| % Difference | 34% | 0.8 | 1.4% | 8.6% |

### Comparative Example 2 (Baseline Condition: Plasma Torch with Smooth Anode)

Plasma testing was performed at the PST TAFA Division site, utilizing a Model 7700 UPC system with a Model SG 100, 2086A Extension plasma spray torch. The conventional plasma spray torch utilized a smooth as-machined surface finish along its outer diameter and had a surface finish of less than 32 Ra. The modified plasma spray torch utilized a ribbed feature along an outer diameter of the anode.

The water-cooling circuit for the torch cooling water was the plant closed loop chilled water system. The parameters used for all the tests were as follows:

### Control Console Flows:

Primary Gas—Argon: 150 scfh
Secondary Gas—Hydrogen: 3 scfh
Carrier Gas—Argon: NA (no powder feed utilized)
Water: 5.4 gpm

### Operating Energy:

Amperage 500
Voltage 54

### Gun Manipulation:

No metallurgical samples were generated. Gun was retained in a stationary test stand.
By maintaining constant parameters for all tests, a proper comparison of the invention with the conventional gun could be effectively carried out.

In operation of the conventional plasma torch, a voltage potential was created between a positive lead and a negative lead to generate an arc that bridged the gap therebetween. No powder was injected into the plasma torch. Rather, the plasma torch was retained in a stationary test stand.

The gun was run for a period of less than 30 minutes utilizing the parameters listed above. Upon completion of the test cycle, the smooth anode was removed from the gun for visual inspection.

The smooth anode was found to have a scale accumulation on the outer diameter of its smooth surface as shown in FIG. 8. More than half of the outer surface was covered with scale buildup. This was considered a non-desirable condition.

### Example 4 (Inventive Plasma Torch with Ribbed Anode)

The smooth anode in the plasma torch that was utilized in Comparative Example 2 was replaced with an anode with a ribbed feature along the outer surface of its outer diameter. The gun was run for a period of slightly greater than 30 minutes utilizing the same parameters settings as described in Comparative Example 2. No powder was injected into the plasma torch. Rather, the plasma torch was retained in a stationary test stand. FIG. 8 shows that the ribbed anode did not form any scale buildup along its outer surface, which was a desirable condition.

### Example 5 (Inventive HVOF Torch with Grit Blasted Combustion Chamber and Grit Blasted Barrel)

An HVOF torch with an alternative structurally enhanced roughened feature was tested. Specifically, both surfaces of the outer diameter of the combustion chamber and barrel had a grit blasted profile. FIG. 9 shows a photo of the chamber and barrel prior to the test. The outer diameter surface of the barrel was grit blasted with an aluminum oxide abrasive to create. A portion of the outer diameter of the chamber was grit blasted with an aluminum oxide abrasive. The grit blasted surface profiles were measured to have an Ra of 303 microinches (0.0003 inches) and an Rz of 1804 micrometres (0.0018 inches).

The test condition comprised of using a Model 5220 gun build with the grit blasted chamber and the grit blasted barrel. The thermal spray system/equipment used for the testing was the JP-8000 system with a Model 5220 HVOF thermal spray gun. The water-cooling circuit for the gun cooling water that was utilized was the plant closed loop chilled water system.

The parameters utilized for the torch were as follows:

### Control Console Flows:

Oxygen—2000 scfh,
Fuel—6.5 gph,
Carrier—26 scfh,
Water—˜10.9 gpm

The testing was performed at the PST TAFA Division site. The gun was run for a period of slightly over 30 minutes utilizing the parameters listed above. In this evaluation, no metallurgical coating samples were generated. After completion of the test, the barrel and chamber were removed from the gun for visual examination. It was observed that the barrel and chamber did not have scale deposits on their respective grit blasted outer diameter surfaces. These tests results demonstrated that a grit blasted surface profile performed substantially equivalent to the ribbed surface features. This was considered a desirable/positive condition.

### Example 6 (Extended Duration Test with Inventive HVOF Torch with Ribbed Barrel and Smooth Chamber)

Tests prior to this particular extended duration test had been limited to no more than a 45-minute cycle. Hence, an extended duration test utilizing the previously described HVOF inventive torch was conducted to assess it for accumulation of scale deposits (fouling) during an extended use period. A 40-hour flame time test was performed. The chamber was a standard, as-machined, OEM manufactured combustion tube. The barrel had a ribbed feature along the surface of its outer diameter, as previously described hereinbefore.

The test condition comprised of using a Model 5220 gun build with a smooth, as-machined chamber and a ribbed barrel. The thermal spray system/equipment used for the testing was the JP-8000 system with a Model 5220 HVOF thermal spray gun. The water-cooling circuit for the gun cooling water that was utilized was the plant closed loop chilled water system.

The parameters utilized for the torch were as follows:

### Control Console Flows:

Oxygen—2100 scfh,
Fuel—6.87 gph,
Carrier—26 scfh,
Water—˜11.1 gpm

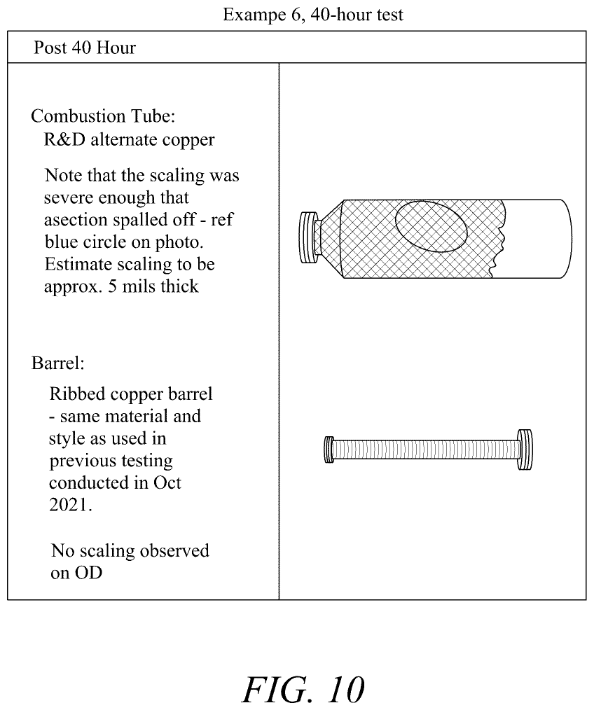

The testing was performed at the PST TAFA Division site. The 40-hour test was conducted over a period of 8 days. To simulate a typical end user's operation, the torch was run for 15 minutes with the flame on, then off for 5 minutes. This was repeated until an accumulation of 40 hours was reached. After achieving a total flame-on time of 40 hours, the combustion tube and ribbed barrel were removed from the torch. The results are shown in FIG. 10. As expected, the combustion tube had a rather significant buildup of scaling. However, the ribbed barrel was found to be absent of any fouling, validating that the inventive ribbed feature protected the component surface from accumulating a scale build-up over long operational conditions.

### Example 7 (Inventive HVOF Torch with Knurled Combustion Chamber and Smooth Barrel)

An HVOF torch with an alternative structurally enhanced roughened feature was tested. Specifically, a portion of the outer diameter of the chamber was machined with the addition of a “knurled” surface as shown in FIG. 11. The knurling raised profile had a cut depth that was measured to be approximately 0.012″-0.015″. The barrel was a smooth, as-machined surface along its outer diameter, as shown in FIG. 11.

The test parameters and the remainder of the testing equipment were the same as used in Example 5. No metallurgical coating samples were generated. The HVOF torch was operated such that the duration of flame-on time was 60 minutes. After 60 minutes, the chamber was inspected. FIG. 11 shows a photo of the chamber and barrel. The chamber showed no scale build-up, which was a positive condition. The smooth barrel exhibited scale build-upon its outer diameter surface.

While it has been shown and described what is considered to be certain embodiments of the invention, it will, of course, be understood that various modifications and changes in form or detail can readily be made without departing from the spirit and scope of the invention. It is, therefore, intended that this invention is not limited to the exact form and detail herein shown and described, nor to anything less than the whole of the invention herein disclosed and hereinafter claimed.

1. An improved thermal spray apparatus for use in production of a thermal spray coating, said improved thermal spray apparatus comprising:
a high velocity oxygen fuel (HVOF) torch for spraying, wherein said torch includes a combustion chamber having an interior volume defined by interior surfaces, said combustion chamber configured to receive oxygen and a fuel and allow combustion reaction products to be produced that generate a heated flow therefrom and which are in contact with said interior surfaces, said combustion chamber comprising a first outer surface in contact with cooling media;
a barrel operably connected downstream to said combustion chamber, said barrel having an interior volume defined by interior surfaces configured to be in contact with the heated flow of said combustion reaction products, said barrel comprising a second outer surface in contact with the cooling media;
at least one of said first outer surface of said combustion chamber and said second outer surface of said barrel characterized by structurally enhanced roughened features, wherein said structurally enhanced roughened features are configured to reduce an accumulation of scale deposits on said first and/or second outer surface when said first and/or second outer surface is exposed to cooling media during the operation of the HVOF torch.

2. The improved thermal spray component apparatus of claim 1, wherein the structurally enhanced roughened features are contained along the second outer surface of the barrel.

3. The improved thermal spray component apparatus of claim 1, wherein the structurally enhanced roughened features are contained along the first outer surface of the combustion chamber.

4. The improved thermal spray component apparatus of claim 1, wherein the structurally enhanced roughened features are contained along the first outer surface of the combustion chamber and the second outer surface of the barrel.

5. The improved thermal spray component apparatus of claim 1, wherein the structurally enhanced roughened features comprises helical threads extending along an entirety or a portion of said first and/or second outer surface, said helical threads having a predefined depth.

6. The improved thermal spray component apparatus of claim 1, wherein the cooling media is water-based.

7. The improved thermal spray component apparatus of claim 1, wherein the structurally enhanced roughened features are characterized by an average surface roughness that is designated as (Ra) of greater than 84 along the first outer surface and/or the second outer surface.

8. An improved thermal spray apparatus for use in a production of thermal spray coating, said improved thermal spray apparatus comprising:
a plasma torch for spraying wherein said torch includes a cathode device, and an anode, said anode having an exterior surface and an interior portion, wherein the interior portion of the anode is operably connected to the cathode device, and further wherein the exterior surface of the anode is in fluid communication with a cooling media;
said exterior surface of the anode characterized by structurally enhanced roughened features, wherein said structurally enhanced roughened features are configured to reduce an accumulation of scale deposits on said external surface of the anode when exposed to cooling media during the operation of the plasma torch.

9. The improved thermal spray component apparatus of claim 8, wherein the structurally enhanced roughened features are characterized by an average surface roughness of a surface that is designated as (Ra) of greater than 84.

10. The improved thermal spray component apparatus of claim 8, wherein the cooling media is water-based.

11. The improved thermal spray component apparatus of claim 8, wherein the structurally enhanced roughened features extend along an entirety or a portion of said outer surface, in helical manner.

12. An improved thermal spray component for use in a thermal spray apparatus to create a thermal spray coating, said improved thermal spray component comprising:
a body having a substantially tubular geometry, said substantially tubular geometry having a first end and a second end, wherein a central longitudinal axis traverses the body from the first end to the second end, the body having a first surface that is adapted to be in contact with a plasma arc or combustion reaction products when said thermal spray component is operably connected within the thermal spray apparatus, the body further having a second surface that extends from the first end to the second end, the second surface configured to be in contact with cooling media during operation of the thermal spray apparatus; and
a structurally enhanced roughened feature along at least a portion of the second surface, said structurally enhanced roughed feature being oriented substantially parallel to the central longitudinal axis, wherein said structurally enhanced roughened features are configured to reduce an accumulation of scale deposits on said second surface when said second surface is exposed to the cooling media during the operation of the thermal spray apparatus.

13. The improved thermal spray component of claim 12, wherein said first surface is an inner surface and said second surface is an outer surface.

14. The improved thermal spray component of claim 12, wherein said improved thermal spray component is an anode.

15. The improved thermal spray component of claim 12, wherein said improved thermal spray component is a combustion chamber.

16. The improved thermal spray component of claim 12, wherein said improved thermal spray component is a barrel.

17. The improved thermal spray component of claim 12, wherein said structurally enhanced roughened feature comprises a grit blasted profile along the second surface.

18. The improved thermal spray component of claim 12, wherein said structurally enhanced roughened feature is characterized by an average surface roughness that is designated as (Ra) of greater than 84 along the second outer surface.

19. The improved thermal spray component of claim 12, wherein said structurally enhanced roughened feature comprises a knurled profile, said grooves extending circumferentially in a helical-like pattern along the second surface.

20. The improved thermal spray component of claim 12, wherein said structurally enhanced roughened feature comprises grooves circumferentially extending along the second surface in a helical-like pattern, said grooves separated from each other by a predefined distance, said grooves further having a predetermined depth within the second surface.

21. An improved thermal spray component for use in a thermal spray apparatus to create a thermal spray coating, said improved thermal spray component comprising:
a body having a substantially tubular geometry, said substantially tubular geometry having a first end and a second end, wherein a central longitudinal axis traverses the body from the first end to the second end, the body having a first surface that is adapted to be in contact with a plasma arc or combustion reaction products when said thermal spray component is operably connected within the thermal spray apparatus;
the body further having a second wetted surface that extends from the first end to the second end, wherein at least a portion of the second wetted surface comprises a structurally enhanced roughened feature that is configured to be in contact with cooling media during operation of the thermal spray apparatus.

22. A method of creating consistent coating properties during operation of an improved thermal spray apparatus, comprising the steps of:
creating a high temperature energy source with the improved thermal spray apparatus comprising at least one thermal spray component having a wetted surface, said wetted surface having a structurally enhanced roughened feature therealong;
introducing powder or wire feedstock into an inlet of the improved thermal spray apparatus;
heating the powder or the wire feedstock to produce substantially molten particles;
introducing cooling media into the improved thermal spray apparatus so as to contact the wetted surface having the structurally enhanced roughened feature therealong;
directing the substantially molten particles onto a substrate to produce a coating, wherein said coating includes at least one coating property that exhibits variation during the operation of the improved thermal spray apparatus that is less than that produced with a thermal spray apparatus that does not contain the at least one thermal spray component, said at least one coating property selected from the group consisting of porosity, deposition thickness, microhardness and residual stress.
